(19) United States
(12) Patent Application Publication
(10) Pub. No.: US 2017/0041254 A1
(43) Pub. Date: Feb. 9, 2017

(54) CONTEXTUAL CONTENT SHARING USING CONVERSATION MEDIUM

(71) Applicant: ITTIAM SYSTEMS (P) LTD., Bangalore (IN)

(72) Inventors: ANIL KUMAR AGARA VENKATESHA RAO, Bangalore (IN); SATTAM DASGUPTA, Bangalore (IN); DURGA VENKATA NARAYANABABU LAVETI, Bangalore (IN)

(21) Appl. No.: 15/226,970

(22) Filed: Aug. 3, 2016

(30) Foreign Application Priority Data
Aug. 3, 2015 (IN) 4026/CHE/2015

(51) Int. Cl. H04L 12/58; H04L 29/08

(52) U.S. Cl. CPC H04L 51/04; H04L 67/26; H04L 67/306; H04L 51/32; H04L 67/02

(57) ABSTRACT

In one example, a method for providing contextual content sharing is described. A unique identifier may be associated with content to be shared with at least one recipient device by a contextual content sharing module residing in a transmitting device. The content may be shared to the at least one recipient device by the contextual content sharing module. Further, at least one message associated with the content may be tagged to the unique identifier associated with the content by the contextual content sharing module. The at least one tagged message and the unique identifier may be shared to the at least one recipient device by the contextual content sharing module to provide the contextual content sharing of the at least one tagged message.

### RELATED APPLICATION

Benefit is claimed under 35 U.S.C. 119(a) to Indian Provisional Patent Application Serial No. 4026/CHE/2015 entitled “CONTEXTUAL CONTENT SHARING USING CHAT AS A CONVERSATION MEDIUM IN REAL-TIME ASYNCHRONOUS COLLABORATION” by ITTIAM SYSTEMS (P) LTD, filed on Aug. 3, 2015.

### TECHNICAL FIELD

The present disclosure generally relates to content sharing, and particularly to contextual content sharing using chat as a conversation medium in real-time asynchronous collaboration.

### BACKGROUND

With advancement of technology, streaming and sharing content (e.g., voice, video, text, image content, and the like) has significantly increased. Typically, content may be shared using an asynchronous method or a synchronous method. In asynchronous method, the content can be shared between users regardless of whether the users are currently online or offline Example asynchronous content sharing may include sending e-mail with attachments, sharing the content and comments over social networking application (e.g., Facebook and messaging application), and the like. In these applications, a user can access the shared content at available time, however, the context of the shared content may be lost or require some overhead to bring the context of the shared content.

In synchronous method, the content may be shared between users who are simultaneously online. Example synchronous content sharing may include applications such as Cisco's webex application. In this application, the online users who are in conversation may get the complete context of the shared content with less overhead. However, this method involves the logistics of finding people (i.e., online users) to be available at the same time (e.g., especially in consumer centric scenarios). As a result, although some applications may achieve a user experience over synchronous ways of sharing content, they may not be as popular as the asynchronous way of sharing the content.

### BRIEF DESCRIPTION OF THE DRAWINGS

FIG. 1 illustrates an example system for contextual content sharing across end points using a conversation medium in real-time asynchronous collaboration;

FIG. 2 illustrates an example block diagram illustrating major components of a contextual content sharing module residing in each end point, such as shown in FIG. 1;

FIG. 3 illustrates an example block diagram of a picture processing and transmission unit of the contextual content sharing module at the transmitting end;

FIG. 4 illustrates an example block diagram of a picture receiving and processing unit of the contextual content sharing module at the receiving end;

FIG. 5 illustrates an example block diagram a message processing and transmission unit of the contextual content sharing module at the transmitting end;

FIG. 6 illustrates an example block diagram of a message receiving and processing unit of the contextual content sharing module at the receiving end;

FIG. 7A depicts an example user interface displaying content and an associated tag at transmitting end;

FIG. 7B depicts an example user interface displaying content and an associated tag at one of receiving ends;

FIG. 8A depicts another example user interface displaying a set of thumbnails associated with various content and the messages that may be shared in a group conversation medium;

FIG. 8B depicts the example user interface displaying chat message and the content associated with a thumbnail upon selecting the thumbnail;

FIGS. 9A and 9B illustrate example flow charts of a method to provide contextual content sharing using chat as a conversation medium; and

FIG. 10 illustrates a block diagram of an example computing device to provide contextual content sharing using chat as a conversation medium.

### DETAILED DESCRIPTION

Embodiments described herein may provide a contextual content sharing using chat as a conversation medium, for instance, asynchronous collaboration. Example content may include digital content such as voice, video, text, image, music, maps, graphics content (e.g., games), documents (e.g., PDF and word) and the like. Upon sharing the content, the users may start to converse about the shared content. For example, the conversation may be accomplished using conversation medium such as text messages (e.g., chat messages), voice tags, gestures, doodle, and the like. Used herein, the user may be an administrator, a participant, a host, an online user, and/or an active user. The term “administrator” may refer to a user who creates an entry of users into the group which will converse in the asynchronous/synchronous manner. The term “participant” may refer to a user who is part of the group that administrator created or may add at a later point in time. The term “host” may refer to a user whoever recently adds a content to the sharing mechanism at any given point in time and continues as the host until another user adds another content. The term “online user” may refer to a user who is online as far as the application is concerned (i.e., the service can delivery messages/notification to user). The term “active user” may refer to a user who is active if he/she is on the activity of interest (i.e., not just active on the application, but seeing the activity of interest, say a picture or a video or a music/speech). The term “offline user” may refer to a user who is offline either if he/she has logged off or if he/she is not connected to the network from the application.

In asynchronous content sharing, content can be shared between users regardless of whether the users are currently online or offline. Example asynchronous content sharing may include e-mail with attachments, sharing the content and comments over social networking application (e.g., Facebook and messaging application), and the like. Active users may send messages (e.g., chat) corresponding to the content that is shared by the host. When an online user (who is offline at the time of sharing) accesses/receives the shared content, the online user may lose the context of the shared content or require some overhead to bring the context of the shared content.

Examples described herein may provide a system technique and a method for contextual content sharing using a conversation medium in asynchronous collaboration. The conversation medium may include chat messages, comments, or voice tags that may be coupled/tagged with a shared content, such that users may get the context of the tags associated with the shared content regardless of whether the users are currently online or offline. For example, a “user A” may tag a message with the content (e.g., while watching a video/seeing a picture). The tagging may be made, e.g., at a particular point in a frame of the image or at a particular time of playback of a video file. In another example, the image may be the content and chat messages may be the conversation medium. Example content may also include graphics, video, music, speech, maps, documents, and the like. Example tagging may also include conversation medium such as text messages, voice tags, gestures, doodle, and the like.

When the host sends/shares a picture (e.g., PIC 1) to at least one user (e.g., active user, online user and offline user), the devices of the active users may display the shared picture (e.g., PIC 1) as a background picture in full-screen mode. In another example, the background picture of the users may remain unchanged until the active/online users receive a message (e.g., MSG-1) that is associated with the shared picture (e.g., PIC 1). At this instance, only an indication may be shown with the message (e.g., MSG-1) that a new picture (e.g., PIC 1) has been added by the host to the users.

Each of the participants (i.e., users) may have the flexibility to change the current picture (i.e., background picture) that they are viewing despite their screen showing the latest added picture from the host. However, the context/synch of chat messages associated with the shared picture, may be accomplished as follows:
a. Let us assume host A has sent the picture (e.g., PIC 1)
b. Active users B and C may view the picture (e.g., PIC 1) as the background picture in full-screen mode, upon receiving the picture (e.g., PIC 1) from the host. In one example, the picture (e.g., PIC 1) may be displayed as the background picture by using the following mechanism,
   i. When host A sends a first message (e.g., MSG 1) associated with (e.g., PIC 1) to all participants, a small thumbnail of picture (e.g., T1) may be sent along with the first message (e.g., MSG 1).
   ii. Each of the active users B and C can immediately see the first message (e.g., MSG 1) along with the small thumbnail of picture (e.g., T1) while the picture (e.g., PIC 1) gets downloaded (e.g., by showing a progress bar to indicate that the download is happening).
   iii. Once the download of the picture (e.g., PIC 1) is complete, the background image may become clean, with full quality of the original picture.
c. If host A and active users B and C are viewing the changed background picture (e.g., PIC 1), then the users (e.g., A, B, and C) may all be in sync and can start chatting with respect to the picture (e.g., PIC 1).
d. Active users B or C can still change the picture (e.g., PIC 1) that they are viewing. The chat may continue in chronological order. For example consider the host A is chatting about the picture (e.g., PIC 1) and the active user B is on a picture (e.g., PIC 2) and the active user C is on a picture (e.g., PIC 3). In this case, the active users B and C may still see chat messages from the host A on the respective background images (i.e., PIC 2 and PIC 3), chronologically.
e. The messages from each of the participant should be (e.g., upon user's choice) tagged to the background picture. For example, each message may arrive with say a labeled small image (e.g., thumbnail) indicating that the sender is on that particular picture (i.e., background picture). Further, when the user clicks the labeled small image or the message, the picture associated with the labeled small image may transitioned as the background image.
   i. In one example, a SIP protocol may be used for messaging while in another example, XMPP may be used. Proprietary protocols may be used for messaging text, voice or any other means of communication channel that will serve the purpose of asynchronous communication.
   ii. In one example, the tagging can be accomplished by generating a unique identifier (ID) on the client side, associated with a unique client ID (making sure that the final ID generated is unique for the session) and transmitting the ID to all participants. From then on, all the messages associated with that particular picture can be associated with this unique ID.
f. In one example, an explicit ‘huddle’ button may be available for each of the participants in the group for generating an alert to change or changing the background image for all active users to the same picture that the user who pressed the ‘huddle’ button is viewing.
g. A participant (e.g., active user B) can edit (e.g., zoom, pan, point, doodle and the like) the background picture (e.g., PIC 1 shared by the host A) and further may choose to ‘update’ the edited picture (e.g., zooming and pointing/doodling to a particular area in the picture PIC 1). In this case, the active user B may become the host for the edited picture (e.g., edited PIC 1), even if the picture (e.g., PIC 1) wasn't shared by the active user B. The edited picture that is shared by the new host B may appear on all other participants' devices. Example edited picture (e.g., edited PIC 1) may be viewed as background image with the pointer and zoomed area cropped while the users (e.g. A, B, and C who are active/online) may continue to chat.

For the aforementioned example, consider a user D in the group is offline when the other users (i.e., A, B and C) of the group 1 are simultaneously online. Thereby, the offline user D behavior may be given as follows:
a. When the user D opens the messages (e.g., MSG 1 to MSG N) sent in the group, the user D is taken to the first unread message (e.g., MSG 1). If the first unread message (e.g., MSG 1) is the message sent by the host A soon after adding/sending the picture (e.g., PIC 1), the background image changes to PIC 1 for the user D.
b. As the user D scrolls down the messages (e.g., MSG 1 to MSG N), for every message (e.g., MSG 2) sent by a person (e.g., user B) who is on the background image (e.g., PIC 2), there is a tag that is clickable in the message. If the user D clicks the message (e.g., MSG 2), the background mage for the user D may change to the picture (e.g., PIC 2).
c. In one example, every time a host adds a picture and the host's message crosses a ‘virtual line’ in the message box, the background image for the user may change and remain so until another host adds a picture and sends a message.
d. The user D may change the pictures pro-actively and independently while he/she scrolls the messages (e.g., MSG 1 to MSG N) or may see a change in background image without any pro-active input, in one example, when a host's message arrives on the picture added by the host. In another example, while the user D scrolls, the background image can change to picture (e.g., PIC 4) as soon as the message (e.g., MSG 4) associated with the picture (e.g., PIC 4) appears on the screen, irrespective of who added the picture (e.g., PIC 4) or who send the message (e.g., MSG 4) to show the context and association of PIC 4 and MSG 4.

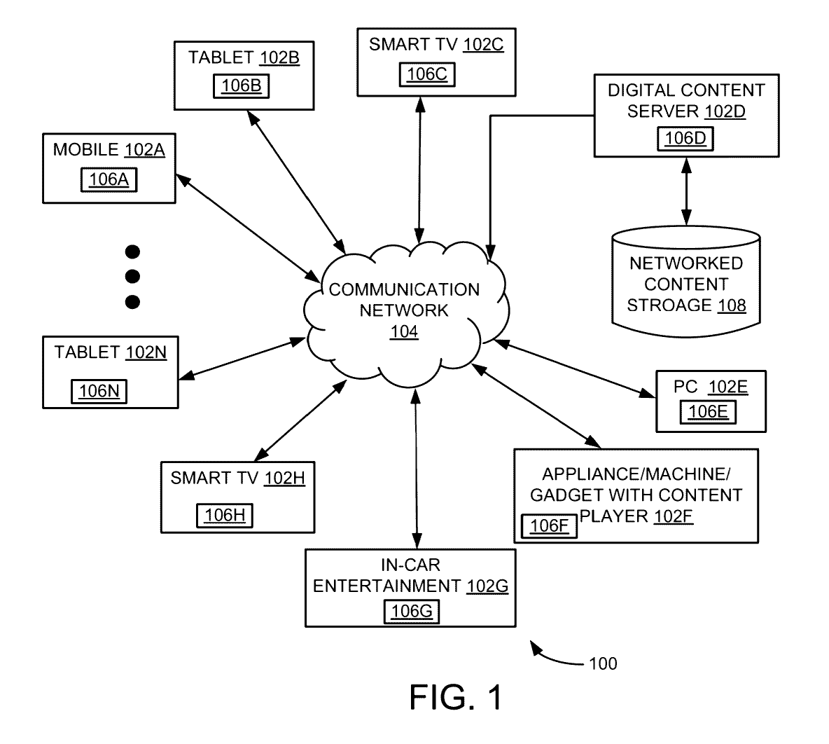

Referring to FIG. 1, the system 100 may include communication devices 102A-N connected over a communication network 104. Each of the communication devices 102A-N may include an associated one of contextual content sharing modules 106A-N. Example communication devices 102A-N (e.g., computing devices) may be smart phones, tablets, smart TV, personal computer (PC), digital content server connected to a content storage 108, and content player incorporated in car, machine, any appliances and the like.

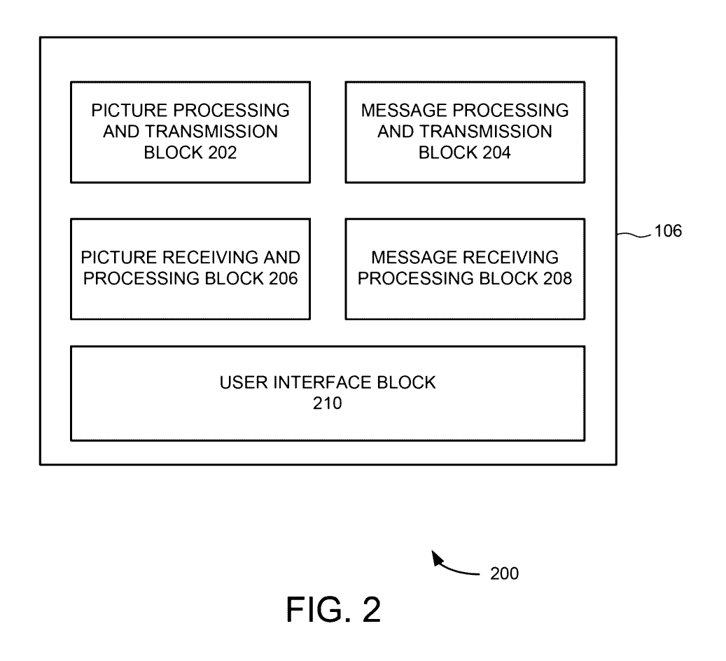

In operation, the contextual content sharing modules 106A-N may enable contextual content sharing using chat as a conversation medium in asynchronous collaboration. For example, one participating end-point (e.g., communication device 102A) can act as a transmitting device to send/share images through the contextual content sharing module 106A and the other participating endpoint(s) 1026-N can act as receiving devices to receive the shared images through respective contextual content sharing modules 1066-N. The example operation of contextual content sharing module at the transmitting end and at the receiving end is described with respect to FIGS. 2-8, respectively.

Referring now to FIG. 2, which depicts an example block diagram 200, showing sub-components of the contextual content sharing module 106. In one example, the contextual content sharing module 106 may reside in a memory of the computing device and executed by a processor of the computing device to perform the contextual content sharing using chat as a conversation medium. The contextual content sharing module 106 may include a picture processing and transmission (PPT) block 202, a message processing and transmission (MPT) block 204, a picture receiving and processing (PRP) block 206, a message receiving and processing (MRP) block 208 and a user interface block (UIB) 210. The UIB 210 may be in communication with the PPT block 202, the PRP block 204, the MPT block 206, and the MRP block 208. Further the UIB may provide a seamless “user experience” via a user interface. Example user interface may include an input and display unit such as display screen, touch screen, and the like.

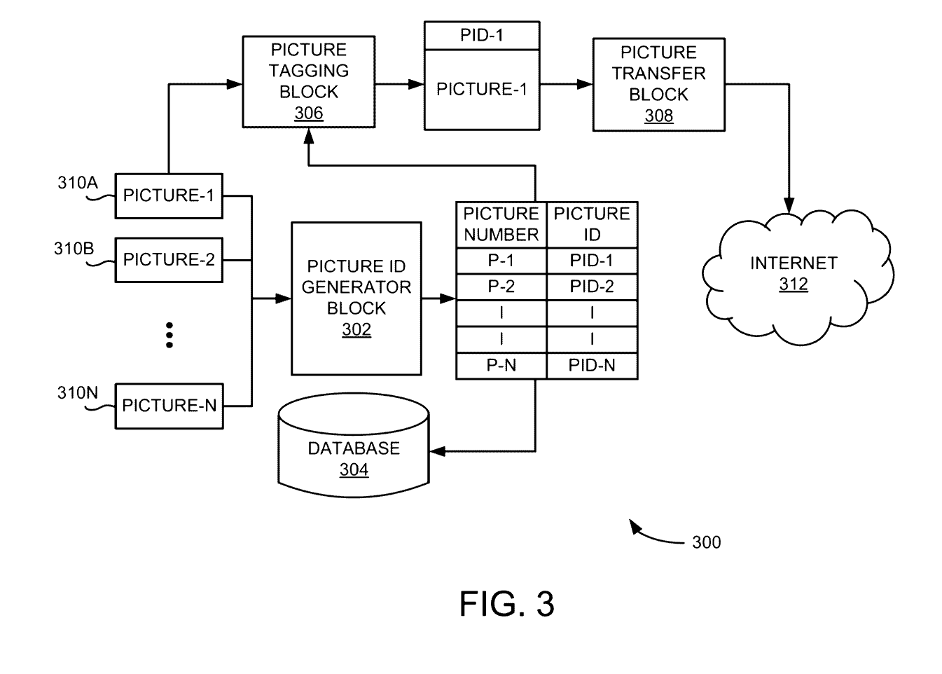

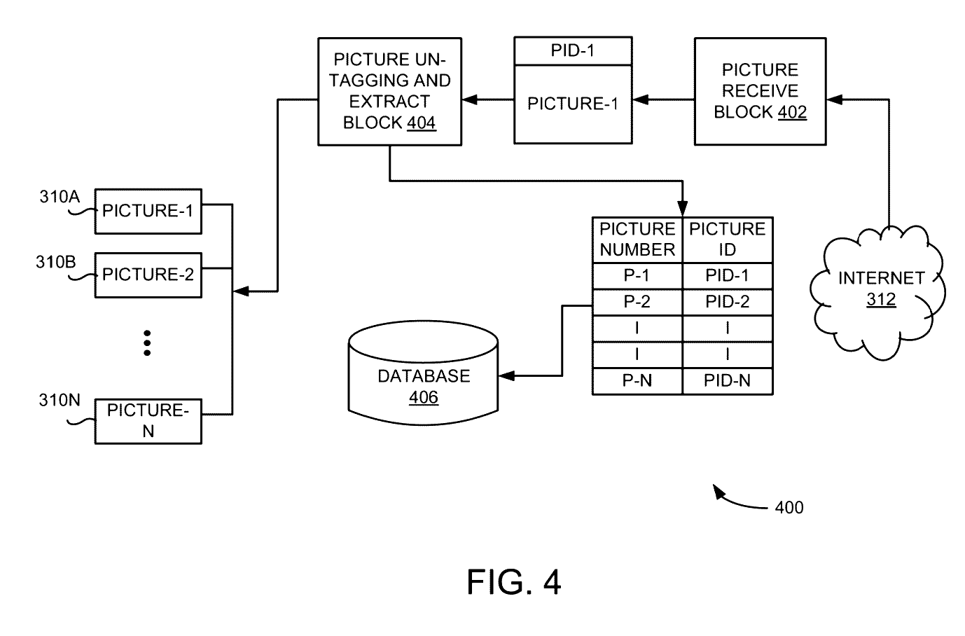

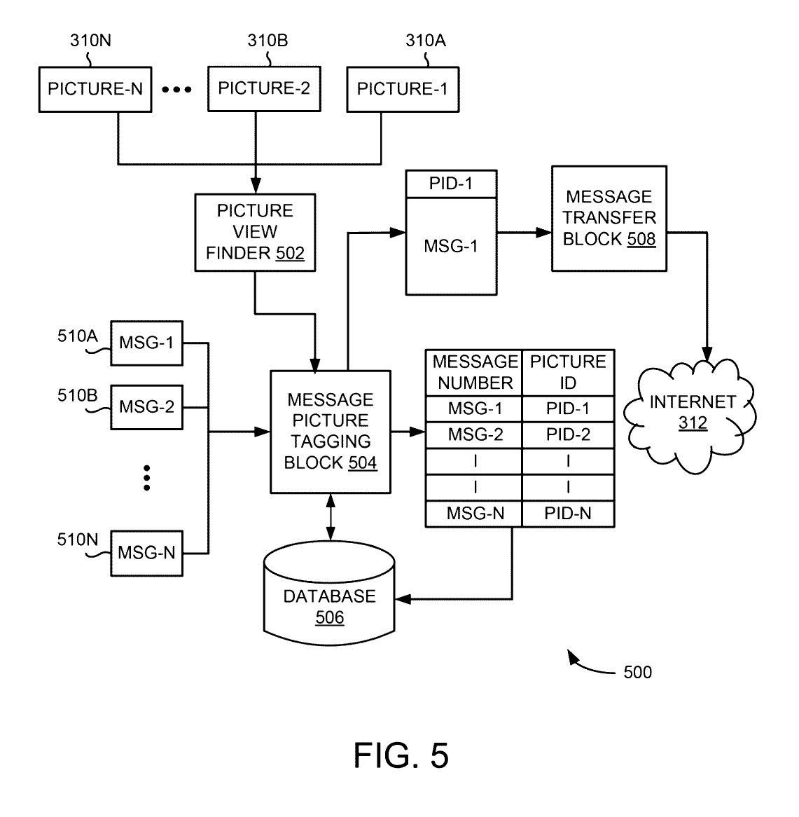

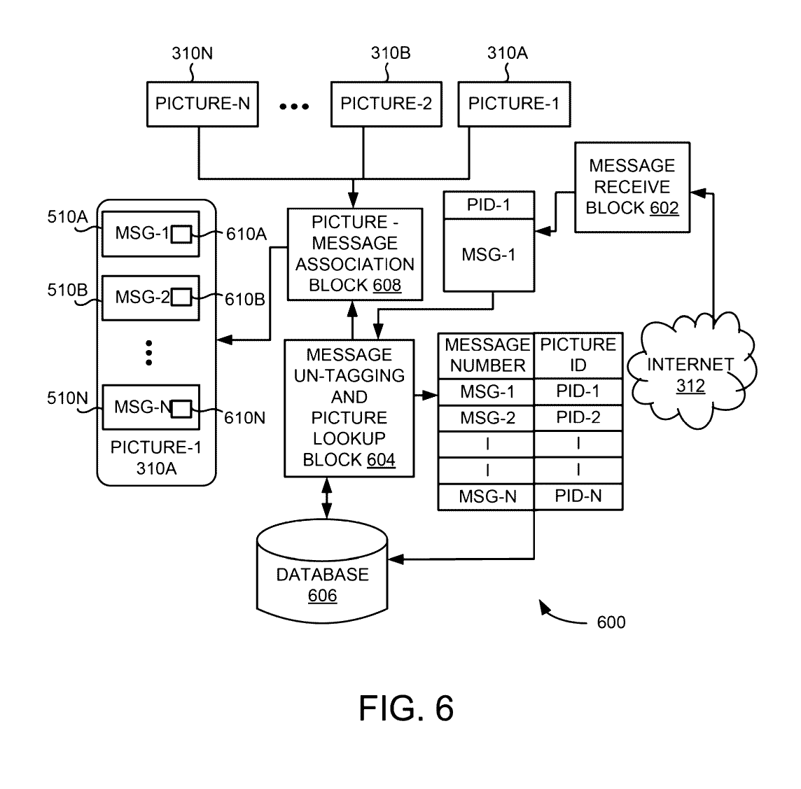

The contextual content sharing module 106 may perform the contextual content sharing using the PPT block 202 and the MPT block 204 at the transmitting end, and the PRP block 206 and the MRP block 208 at the receiving end. The example operation of PPT block 202 and the MPT block 204 at the transmitting end is described with respect to FIGS. 3 and 5, respectively. The example operation of the PRP block 206, and the MRP block 208 at the receiving end is described with respect to FIGS. 4 and 6, respectively. The contextual content sharing may be one or two-way interaction between two or more participants, one-way transmission from one source to one or more people, or a combination of both. In one example, the content may be communicated between two or more participants interacting with each other. In other example, the content may be communicated to two or more participants who can receive the content and communication channel from the host without necessarily a back-channel to interact with the transmission side (e.g., host).

The PPT block 202 may generate and associate a unique identifier with a first content (e.g., audio, video, text, and/or image content) to be shared with at least one recipient device. Further, the PPT block 202 may share the first content to the at least one recipient device, for instance, in a group conversation medium. For example, the first content can be shared to the at least one recipient device either by uploading the content to a cloud storage and sharing a uniform resource locator (URL) of the stored content with the at least one recipient device, or directly transferring the content to the at least one recipient device over the internet. Example implementation of the functions of the PPT block 202 is explained in conjunction with FIG. 3.

The MPT block 204 may associate at least one first message (e.g., chat message) to the first content using the unique identifier associated with the content and share the at least one first message and the unique identifier to the at least one recipient device to provide the contextual content sharing of the at least one message. Example implementation of the functions of the MPT block 204 is explained in conjunction with FIG. 5.

Furthermore, the PRP block 206 may receive second content (e.g., audio, video, text, and/or image content) from the at least one recipient device. In one example, the second content may include a modified version of the first content, the modified version may include editing functions selected from a group consisting of doodling, pointer with zoom, pan, and/or rotate features on the first content. In this case, the PRP block 206 may receive the modified version of the first content as a new content with a different unique identifier or as the first content having the same unique identifier along with the editing functions. The computing device may include a database to store the first content, the second content and unique identifiers associated with the first content and the second content for later use. Example implementation of the functions of the PRP block 206 is explained in conjunction with FIG. 4.

The MRP block 208 may receive at least one second message (e.g., chat message) and a unique identifier associated with the second content from the at least one recipient device. Further, the MRP block 208 may associate the at least one second message with the second content using the unique identifier. In one example, the MRP block 208 may associate the at least one second message with the second content by extracting thumbnail associated with the second content using the unique identifier associated with the second content.

Then, the MRP block 208 may render the at least one second message and associated second content on a display of the computing device. In one example, the MRP block 208 may render the at least one second message with the extracted thumbnail substantially simultaneously. The at least one first message, an associated thumbnail of the first content, the at least one second message and the associated thumbnail of the second content are displayed on a display of the computing device. Example implementation of the functions of the MRP block 208 is explained in conjunction with FIG. 6.

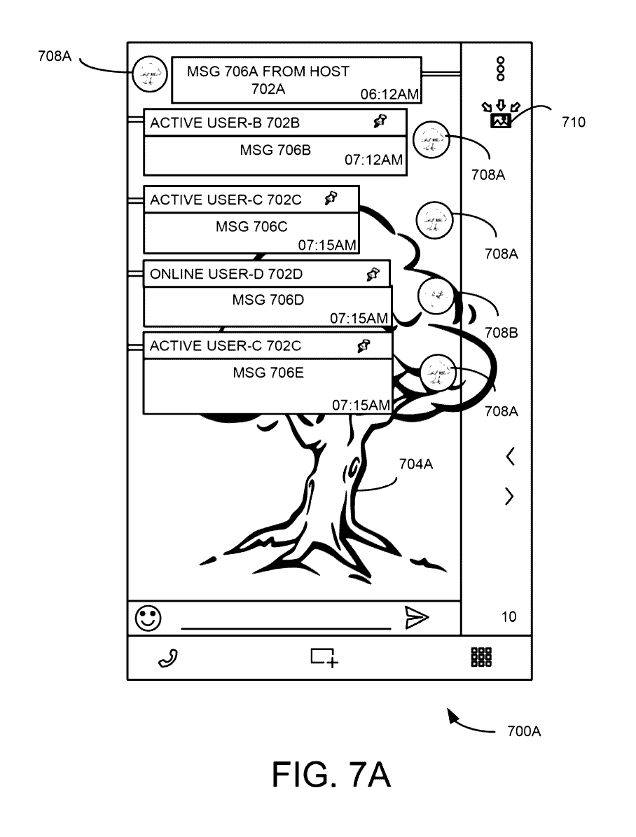

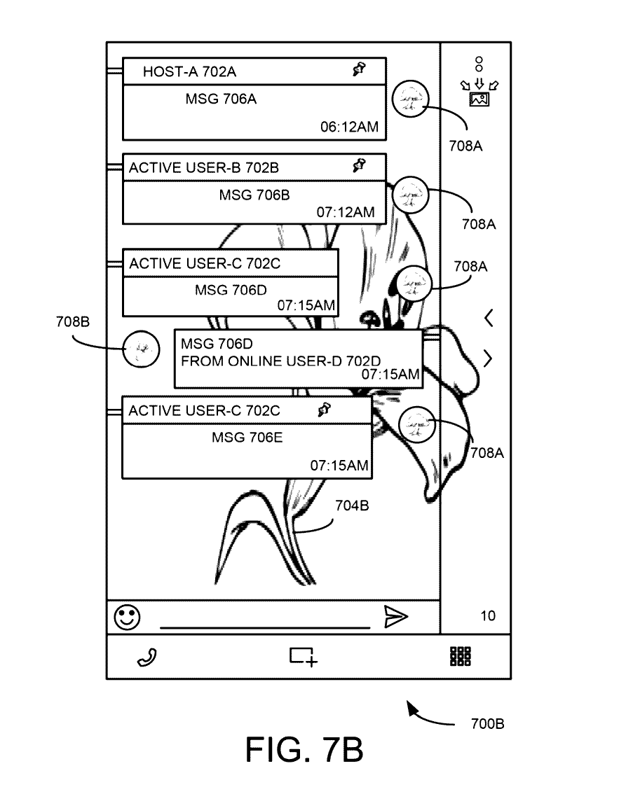

In one example, thumbnails associated with the first content and the second content may be displayed substantially adjacent to the at least one first message and the at least one second message to provide a context of the at least one first message and the at least one second message. Each thumbnail may indicate a content that a user of a computing device and the at least one recipient device is viewing when the at least one first message and the at least one second message was shared, respectively. Further, the MRP block 208 may render second content associated with the extracted thumbnail as a background on a user interface (e.g., user interface 700A as shown in FIG. 7A) upon selecting the extracted thumbnail or the at least one second message associated with the extracted thumbnail.

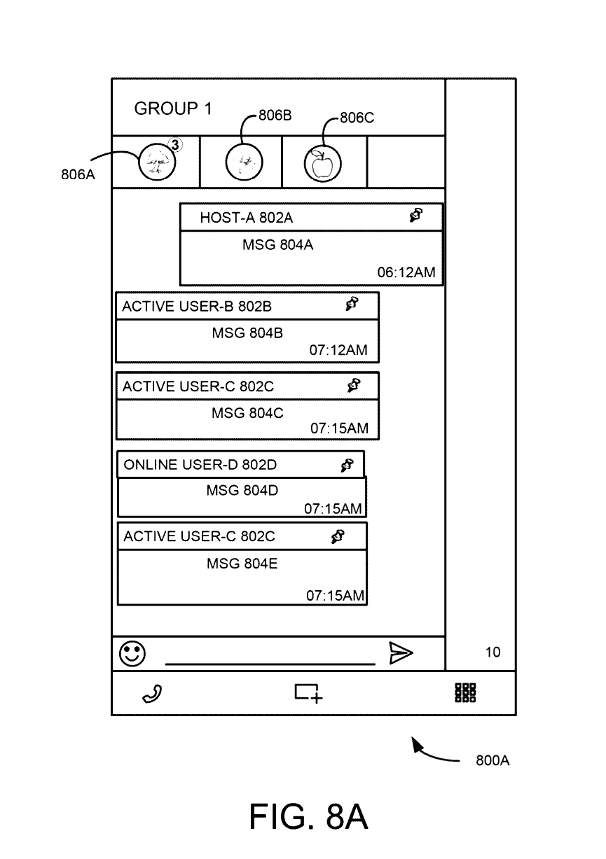

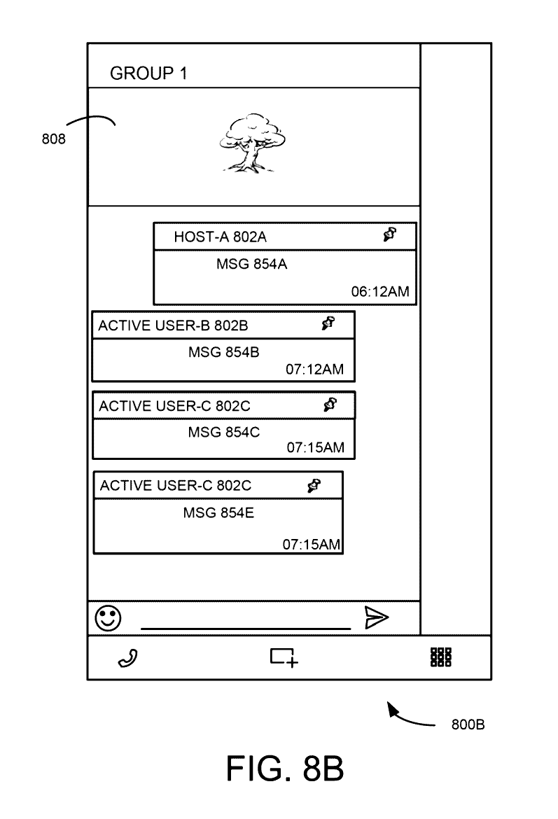

In another example, the MRP block 208 may render a set of thumbnails on a user interface. For example, the user interface may display a set of thumbnails and messages that may be shared in the group conversation medium without being associated with any content. Each thumbnail may be associated with a different content shared in a group conversation medium. The MRP block 208 may prompt a user to select one of the set of thumbnails on the user interface. The MRP block 208 may display a set of messages associated with the selected one of the thumbnails along with the content associated with the selected one of the thumbnails on the user interface (e.g., user interface 800B as shown in FIG. 8B).

FIG. 3 illustrates the example block diagram 300 of the PPT block 202 at the transmitting end. The PPT block 202 may include a picture ID generator block (PIDGB) 302, a database (DB) 304, a picture tagging block (PTGB) 306, and a picture transfer block (PTB) 308. In the example shown in FIG. 3, the PPT block 202 may process and transmit the pictures 310A-310N as the content from the transmitting end to the receiving end. The PIDGB 302 may allocate a unique identifier PID-1 to PID-N to each transmitted picture 310A-310N, respectively. In one example, the picture 310A may be used in multiple conversations, and in each conversation the picture 310A may be allocated with a unique identifier PID-1. The DB 304 connected to the PIDGB 302, may store the hash map associated with the picture and the ID for later use.

The PTGB 306 may receive the hash-map from the PIDGB 302. Further, the PTGB 306 may create a picture tag based on the hash map and associates the picture tag with the corresponding picture 310A-310N. In one example, the picture tagging may be done as a single package as illustrated above or as a secondary channel referring to the corresponding picture. Further, the PTB block 308 may transfer the packaged/tagged picture to the receiving ends over the internet 312. In one example the picture may be uploaded to a cloud storage that either belongs to the user or to service provider (not shown in FIG. 3), in this case only the link (e.g., URL link) of the stored content may get shared with the participants. In another example, the picture may be physically transferred to the participants over the internet and without storing anywhere on the cloud storage.

For example, during group interaction, users of electronic devices may transmit communications that are shared among the electronic devices. For example, group interaction may correspond to a chat session, video chat session, message (e.g., text message, microblog, forum post, etc.) thread, content-sharing service, social networking service, and/or other network-based communication mechanism used by electronic devices. In addition, the users may use group interaction to share content (e.g., content 1, content 2, and the like) with one another. For example, one or more users may upload images, audio, video, documents, files, and/or other content to the group to share the content with other users in group interaction.

FIG. 4 illustrates the example block diagram 400 of the PRP block 206 at the receiving end. The PRP block 206 may include a picture receive block (PRB) 402, a picture un-tagging and extract block (PUTGEB) 404, and a database (DB) 406. The PRB 402 may receive the picture that is transmitted by the transmitting end over the internet 312. When the picture was uploaded to cloud storage and only the link was shared with the participants at the receiving end, in this case the, PRB 402 may download the picture using the URL link provided before un-packaging/un-tagging. The URL link may be provided as a single entity with the transmitted picture having the unique ID. The PUTGEB 404 may unpack/extract the received picture so as to provide associated tag PID-1 to PID-N and the picture 310A-310N. The pictures 310A-310N that may be extracted are ready to be used later. At the same time, the PUTGEB 404 may send the hash-map of the pictures and their corresponding unique IDs to the DB 406 for further processing.

FIG. 5 illustrates the example block diagram 500 of the MPTB 204. The MPTB 204 may include a picture view finder (PVF) 502, a message-picture tagging block (MPTGB) 504, a database (DB) 506, and a message transfer block (MTB) 508. The MPTB 204 may associate the chat messages 510A-510N with the corresponding content (e.g., pictures 310A-310N). The PVF 502 may find and update a current picture that is being viewed by the user (e.g., host, active users and online users) to the MPTGB 504. Alternately, the user may choose to explicitly ‘tag’ the message that he/she sends to a particular picture that is not the current background picture. In that case, the PVF 502 may take this tagging input from the user directly. In one example, the active users B and C may view the picture 310A as the background picture in full-screen mode, upon receiving the picture 310A from the host. In this case, the PVF 502 may update the MPTGB 504 that the picture 301A is viewed by the active users B and C.

Further, the MPTGB 504 may receive the current messages being typed by the user, and then may allocate a unique ID to the typed message, and perform a look-up of the picture ID associated with the picture that the PVF 502 conveyed. Furthermore, the MPTGB 504 may create a hash-map of message (e.g., MSG1 to MSGN) with a corresponding picture ID (PID-1 to PID-N). For the above example, the active user B may respond to the shared picture 310A by typing a message 510B, at this time the background picture of the active user B is the transmitted picture 301A (having unique identity PID-1). In this case, the message 510B is mapped with the picture 310A using the unique identifier PID 1 so as to indicate that active user B is viewing the picture 310A and sending messages associated with the picture 310A.

Furthermore, the MTB 508 may receive the tagged message with the corresponding picture from the MPTGB 504, and send the tagged message along with the picture ID over the internet 312. The message may be transferred to the participants directly or via a cloud based server. In one example, the MTB 508 may also associate a small thumbnail representation of the picture 310A as part of the message MSG-1 (i.e., 510A) either packed or as a secondary channel and transmits the packed message with the thumbnail to the Internet 312. Appending the small thumbnail representation may ensure a good user experience on the receiver side, thereby the message may be displayed with the small thumbnail (low quality) until the actual high quality picture arrives through the picture transmission and receive block (PPT block 202 at the transmitting end and PRP block 206 at the receiving end) and then get associated with the corresponding message. In one example, each thumbnail may be a representation of different content (e.g., photo) that users shared in a group conversation medium.

FIG. 6 illustrates the MRP block 208 at the receiving end. The MRP block 208 may include message receive block (MRB) 602, a message un-tagging and picture lookup block (MUTPLB) 604, a database (DB) 606, and a picture-message association block (PMAB) 608. The MRP block 208 may receive the messages 510A-510N and associates the received messaged with the picture 310A-310N that are received by the PRP block 206 (as shown in FIG. 4) before being presented to the user. The MRB 602 may receive the messages sent by the users in the group, and then extract the associated thumbnail representations 610A-610N and the message 510A-510N having picture identity PID-1 to PID-N, respectively. The MUTPLB 604 may receive the extracted thumbnails 610A-610N from the MRB 602, for displaying the message 510A-510N with associated thumbnail 610A-610N immediately, while the picture gets downloaded/received and displayed in full quality.

Further, the MUTPLB 604 may un-pack the packed message to get the message body 510A-510N and the corresponding picture identity PID-1 to PID-N. Furthermore, the MUTPLB 604 may create a hash-map of the messages 510A-510N and the corresponding picture identities PID-1 to PID-N. The DB 606 may store the hash-map created by the MUTPLB 604 for later use. The PMAB 608 may receive the arrived messages 510A-510N and the picture identities PID-1 to PID-N from the MUTPLB 604. Furthermore, the PMAB 608 may associate the arrived messages 510A-510N and the picture identities PID-1 to PID-N, so as to display a message and a picture that correspond to a picture identity.

In one example, consider a message (MSG-1) 510A corresponds to picture identity PID-1 of picture 310A, received by the active/online user. The PMAB 608 may receive message (MSG-1) 510A and picture identity PID-1 from MUTPLB 604. Further, the PMAB 608 may display the message (MSG-1) 510A on the received picture 310A which is the current background picture. After sometime, another message (MSG-2) 510B may be sent by a same/different host, the message (MSG-2) 510B may correspond to a different picture 310B shared by the same/different host. The MUTPLB 604 may send message (MSG-2) 510B and picture identity PID2 to the PMAB 608. In this case, the PMAB 608 may display message (MSG-2) 510B on picture 310A that was being displayed as background, with an indicator (e.g., thumbnail 6108) or link on the message (MSG-2) 510B to show that the message 510B actually belongs to a different picture 310B instead of current background picture 310A. The user then has a choice to click on the indicator, which may trigger the following sequence of events.
i. The click action may prompt the PMAB 608 to request the corresponding picture identity PID-2 from the MUTPLB 604.
ii. The MUTPLB 604 may perform a DB 606 look-up to retrieve the picture identity PID2 from the hash-map that is created when the message (MSG-2) 510B is received, and provides the picture identity PID-2 to the PMAB 608.
iii. Further, the PMAB 608 may change the picture 310B associated with the picture identity PID-2 as the background picture. At any point in time, the user may also view all the messages (e.g., 510A, 510B, 510C) corresponding to the particular picture 310B.
iv. With the click of another button may remove all the messages (e.g., 510D, 510E, 510F) that do not belong to that particular picture 310B.

In another example, the messages that arrive, which do not belong to the picture the user is seeing are just put into buckets associated with that particular picture and not displayed to the user chronologically. In this case, all the messages associated with each picture gets displayed whenever the user changes the picture without ensuring order of arrival (chronological order) of the messages across images.

Apart from the pictures/images and messages, the contextual content sharing module 106 can have an additional editing functions such as doodling or pointer with optional zoom, pan, and rotate features for the content. In one example, the edited image is saved as a completely new image and sent across as if it was a new image with a new picture/image ID. In another example implementation, only the edit functions (like co-ordinates of the doodle or pointer and the zoom or pan or rotate factor, etc.) may be sent across to the participants/recipients with an association of the original image ID so that the recipients can regenerate the experience that the sender is experiencing.

FIG. 7A depicts an example user interface 700A displaying content and tag at transmitting end (e.g., host). In the example shown in FIG. 7A, the host 702A may share the content 704A to users 702B-702D who are in a chat group. The shared content may be an image/picture of the “tree”, which is tagged with the message 706A (e.g., “jungle tree”), and a thumbnail 708A.

The active users 702B and 702C may view the picture 704A as the background picture at the receiving ends, when the active users 702B and 702C click either the message 706A or the thumbnail 708A. Till the active users 702B and 702C view the picture 704A as the background picture, the chat messages (706G, 7060 and 706E) sent by the active users 702B and 702C may be appended with the thumbnail 708A. Further in the example shown in FIG. 7A, the online user 702D is in conversation but not clicked the message 706A or the thumbnail 708A. In this case, the online user 702D may view a picture 704B (i.e., background picture of the online user 702D as shown in FIG. 7B) that is different from the picture 704A. Thereby, the thumbnail 7088 associated with the picture 704B may be appended next to a message 7060 which is sent by the online user 702D. Any user can change the background picture (the picture she is seeing) by clicking either the message or the thumbnail. In another example, FIG. 7 may illustrate a huddle button 710 to provide an option to send an alert to the at least one recipient device (e.g., active users) 702B-702D to change a background content for the at least one recipient device 702B-702D to the shared content.

FIG. 7B depicts an example user interface 7008 displaying messages as seen by one of the users (e.g., user D), who is not seeing the same picture 704A (as shown in FIG. 7A) as seen by the other users (e.g., host A users B and C). The thumbnails 708A and 708B, next to respective one of the messages 706A-706E from each user 702A-702D, may indicate the picture the user is seeing when the messages 706A-706E were sent. In the example shown in FIG. 7B, the online user 702D is in conversation but not clicked the message 706A or the thumbnail 708A. In this case, the online user 702D may be indicated as viewing a picture 704B (i.e., background picture) that is different from the picture 704A. Thereby, for the online user 702D, the thumbnail 708B associated with the picture 704B may be appended next to the message 7060. Any user can change the background picture (the picture she is seeing) by clicking either the message or the thumbnail next to it.

FIG. 8A depicts another example user interface 800A displaying a set of thumbnails (e.g., 806A, 806B, and 806C) associated with content and the messages that may be shared in a group conversation medium at transmitting end (e.g., host). In the example shown in FIG. 8A, a set of thumbnails 806A, 806B, and 806C may be rendered on a user interface of a group conversation medium. Each thumbnail may represent a content (e.g., photo/picture/video and the like) that users share in the group conversation medium. Also, each thumbnail may be associated with an indicator indicating new unread messages associated with a respective content. Example indicator may include a number indicating a number of unread messages associated with each content. Further, user interface 800A depicts chat messages (e.g., 804A, 804B, 804C, 804D and 804E) that were shared by the users (e.g., 802A, 802B, 802C, and 802D) in the group conversation medium and may not be associated with any content.

FIG. 8B depicts the example user interface 800B displaying chat messages (854A, 854B, 854C, and 854E) associated with a thumbnail 806A along with the content 808 associated with the thumbnail 806A upon selecting the thumbnail 806A from the set of thumbnails. In this case, the messages may be classified into respective one of the set of thumbnails 806A, 806B and 806C based on the received unique identifier associated with each message. In the example shown in FIG. 8B, the host 802A may share a first content 808 to users 802B-802D who are in a chat group. The shared content may be an image/picture of the “tree”, which is tagged with the message 854A (e.g., “jungle tree”), and a thumbnail 806A.

The active users 802B and 802C may view the first content at the receiving ends, when the active users 802B and 802C click the thumbnail 806A. Till the active users 802B and 802C view the first content as a main content on the user interface, the chat messages (e.g., 854B, 854C, and 854E) sent by the active users 802B and 802C may be classified and put into the thumbnail 806A. In one example, when the user of the host 802A selects a thumbnail 806A, then the messages 854A, 854B, 854C, and 854E associated with the selected thumbnail 806A (e.g., messages related to the shared first content 808) that were shared in the group may be displayed along with the content 808 on the user interface 800B. Similarly, the chat messages corresponding to a second content (e.g., indicated by thumbnail 806B) that are sent by users in the group may be classified and put into the thumbnail 806B and can be displayed upon selecting the thumbnail 806B.

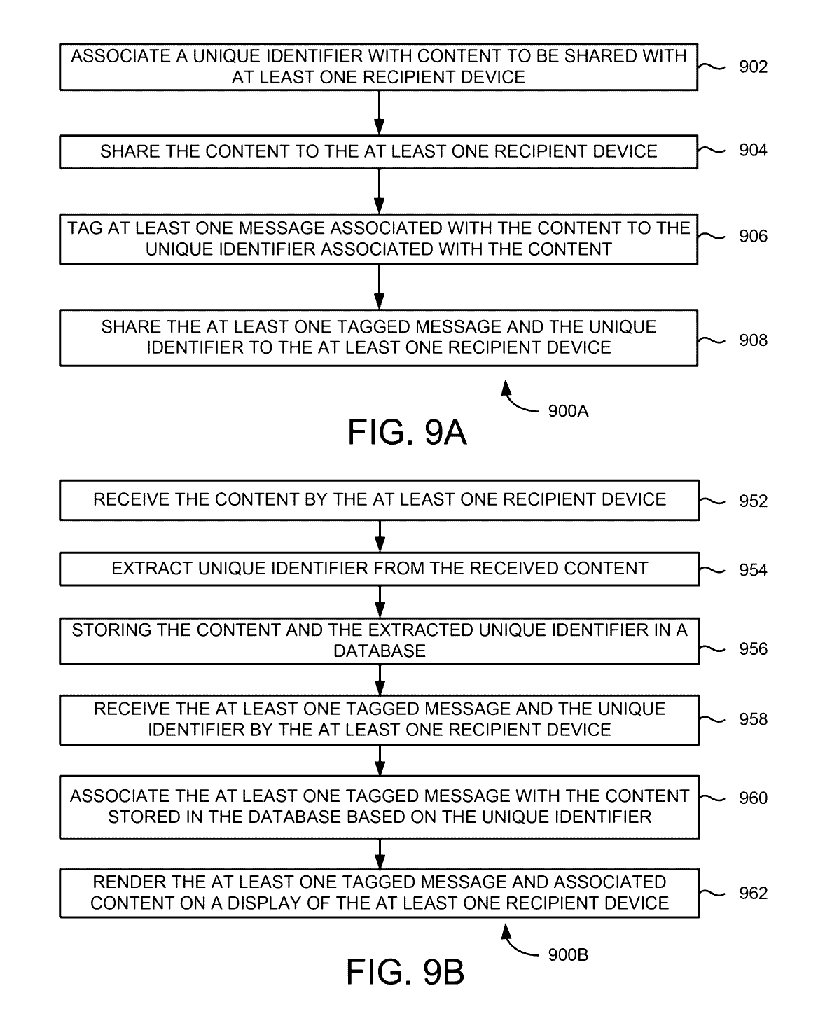

FIGS. 9A and 9B illustrate example flow charts of a method to provide contextual content sharing using chat as a conversation medium. It should be understood the process depicted in FIGS. 9A and 9B represent generalized illustrations, and that other processes may be added or existing processes may be removed, modified, or rearranged without departing from the scope and spirit of the present application. In addition, it should be understood that the processes may represent instructions stored on a computer readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flowcharts illustrate functional information to design or fabricate circuits, generate machine-readable instructions, or use a combination of hardware and machine-readable instructions to perform the illustrated processes.

Particularly, FIG. 9A depicts an example flow chart 900A of a process for contextual content sharing implemented on a transmitting device. At 902, a unique identifier may be associated with content (e.g., audio, video, text, and image content) to be shared with at least one recipient device by a contextual content sharing module residing in the transmitting device. The content can be captured using a camera associated with the transmitting device or obtained from a content storage device. In one example, the content can be shared either by uploading the content to a cloud storage and sharing a uniform resource locator (URL) of the stored content with the at least one recipient device or directly transferring the content to the at least one recipient device over the internet. Further, the content may include a new content (i.e., content to be shared with the group for the first time) or a modified version of a previously shared content. In one example, the modified version of the content can be shared as a new content by creating and associating a new unique identifier to the modified version. In another example, the modified version of the content may be shared with the original unique identifier (i.e., the unique identifier previously associated with the content) along with editing functions (e.g., doodling, pointer with zoom, pan, and/or rotate features).

At 904, the content may be shared to the at least one recipient device by the contextual content sharing module. At 906, at least one message (e.g., chat message) associated with the content may be tagged to the unique identifier associated with the content by the contextual content sharing module. At 908, the at least one tagged message and the unique identifier may be shared to the at least one recipient device by the contextual content sharing module to provide the contextual content sharing of the messages. Further, a user of the transmitting device may have an option to send an alert to the at least one recipient device to change a background content for the at least one recipient device to the shared content.

FIG. 9B depicts an example flow chart 900B of a process for contextual content sharing implemented on at least one recipient device. At 952, the content may be received from the transmitting device by the at least one recipient device. At 954, the unique identifier may be extracted from the received content by a contextual content sharing module residing in the at least one recipient device. At 956, the content and the extracted unique identifier may be stored in a database associated with the at least one recipient device for later use.

At 958, the at least one tagged message and the unique identifier may be received by the at least one recipient device. At 960, the at least one tagged message may be associated with the content stored in the database based on the unique identifier by the contextual content sharing module residing in the at least one recipient device. In one example, a thumbnail associated with the content may be extracted from the database based on the unique identifier and then the at least one tagged message may be associated with the extracted thumbnail.

At 962, the at least one tagged message and associated content may be rendered on a display of the at least one recipient device by the contextual content sharing module residing in the at least one recipient device. In one example, the at least one message along with the extracted thumbnail of the shared content may be rendered on the display of the at least one recipient device. For example, a thumbnail may represent a content that a user of a recipient device is viewing when the messages were shared in the group conversation medium.

In one example, messages and associated unique identifiers may be received from the at least one recipient device in the group conversation medium (e.g., group chat). Further, thumbnails associated with the content may be extracted from a database based on the unique identifiers. In this case, the database may include content and unique identifiers associated with each content that were previously shared in the group conversation medium. Furthermore, the messages may be displayed with thumbnails substantially adjacent to the messages from the at least one recipient device. Also, the content associated with a thumbnail can be rendered as a background on the at least one recipient device upon selecting the thumbnail or message associated with the thumbnail.

In another example, messages and associated unique identifiers may be received from the at least one recipient device in the group conversation medium. The messages may be classified into a set of thumbnails based on the unique identifiers associated with the content. Each thumbnail may indicate content that a user of a recipient device is viewing when the messages were shared in the group conversation medium. The set of thumbnails may be rendered on a user interface of a computing device (e.g., transmitting or recipient device). Furthermore, a user may be prompted to select one of the set of thumbnails. Upon selecting the one of the set of thumbnails, the messages associated with the selected one of the thumbnails may be displayed along with the content associated with the selected one of the thumbnails.

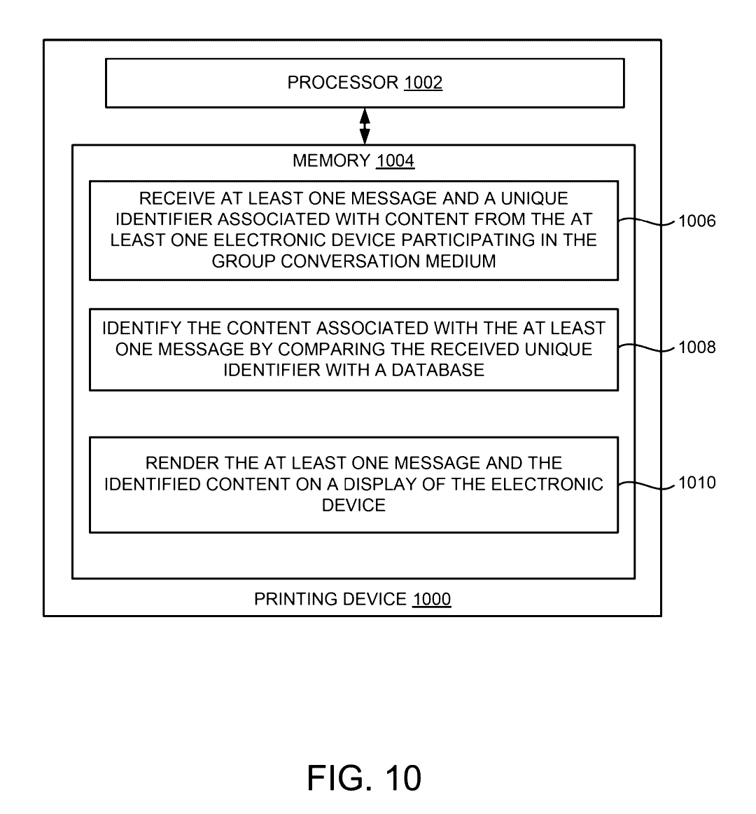

FIG. 10 illustrates a block diagram of an example computing device 1000 to provide contextual content sharing using chat as a conversation medium. Example computing device may include a transmitting device or a recipient device in the group chat. Computing device 1000 may include processor 1002 and a machine-readable storage medium/memory 1004 communicatively coupled through a system bus. Processor 1002 may be any type of central processing unit (CPU), microprocessor, or processing logic that interprets and executes machine-readable instructions stored in machine-readable storage medium 1004. Machine-readable storage medium 1004 may be a random access memory (RAM) or another type of dynamic storage device that may store information and machine-readable instructions that may be executed by processor 1002. For example, machine-readable storage medium 1004 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 1004 may be a non-transitory machine-readable medium. In an example, machine-readable storage medium 1004 may be remote but accessible to computing device 1000.

Machine-readable storage medium 1004 may store instructions 1006-1010. In an example, instructions 1006-1010 may be executed by processor 1002 to provide a contextual content sharing in a group conversation medium. The group conversation medium may be a synchronous conversation medium, asynchronous conversation medium or a combination thereof. The asynchronous conversation medium is a medium in which an interaction is performed without requiring other users of the electronic devices to be online, and the synchronous conversation medium is a medium in which an interaction is performed between the online and active users.

Instructions 1006 may be executed by processor 1002 to receive at least one message (e.g., chat message) and a unique identifier associated with content (e.g., audio, video, text, and/or image content) from the at least one electronic device participating in the group conversation medium. Instructions 1008 may be executed by processor 1002 to identify the content associated with the at least one message by comparing the received unique identifier with a database. For example, the database may include content and unique identifiers associated with the content that were previously shared in the group conversation medium. Instructions 1010 may be executed by processor 1002 to render the at least one message and the identified content on a display of the electronic device.

Also, although certain terms are used primarily herein, other terms could be used interchangeably to yield equivalent embodiments and examples. For example, the term “device” may be used interchangeably with “physical host”, “physical machine”, “physical device”, or “communication device”. Further for example, the terms “host”, “transmitting device” and “sender” may be used interchangeably throughout the document. Furthermore, the terms “client”, “recipient device”, and “receiver” may be used interchangeably throughout the document. The terms “image”, and “picture” may be used interchangeably throughout the document.

It may be noted that the above-described examples of the present solution are for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computing device comprising:
a processor; and
memory coupled to the processor, wherein the memory comprises a contextual content sharing module, wherein the contextual content sharing module comprises:
a picture processing and transmission block to:
associate a unique identifier with a first content to be shared with at least one recipient device; and
share the first content to the at least one recipient device; and
a message processing and transmission block to:
associate at least one first message to the first content using the unique identifier associated with the content; and
share the at least one first message and the unique identifier to the at least one recipient device to provide a contextual content sharing of the at least one message.

2. The computing device of claim 1, wherein the contextual content sharing module comprises:
a picture receiving and processing block to receive a second content from the at least one recipient device; and
a message receiving and processing block to:
receive at least one second message and a unique identifier associated with the second content from the at least one recipient device;
associate the at least one second message with the second content using the unique identifier associated with the second content; and
render the at least one second message and the associated second content on a display of the computing device.

3. The computing device of claim 2, further comprising a database to store the first content, the second content and unique identifiers associated with the first content and the second content.

4. The computing device of claim 2, wherein the message receiving and processing block is to:
associate the at least one second message with the second content by extracting a thumbnail associated with the second content using the unique identifier, and wherein the message receiving and processing block is to render the at least one second message with the extracted thumbnail substantially simultaneously.

5. The computing device of claim 4, wherein the message receiving and processing block is to render the second content associated with the extracted thumbnail as a background upon selecting the extracted thumbnail or the at least one second message associated with the extracted thumbnail.

6. The computing device of claim 4, wherein the at least one first message, an associated thumbnail of the first content, the at least one second message and the associated thumbnail of the second content are displayed on the display of the computing device.

7. The computing device of claim 4, wherein thumbnails associated with the first content and the second content are displayed substantially adjacent to the at least one first message and the at least one second message, respectively, to provide a context of the at least one first message and the at least one second message, wherein each thumbnail indicates a content that a user of a computing device and the at least one recipient device is viewing when the at least one first message and the at east one second message was shared.

8. The computing device of claim 4, wherein the message receiving and processing block to:
render a set of thumbnails on a user interface, each thumbnail associated with a different content shared in a group conversation medium;
prompt to select one of the set of thumbnails on the user interface; and
display a set of messages associated with the selected one of the thumbnails along with the content associated with the selected one of the thumbnails on the user interface.

9. The computing device of claim 2, wherein the second content comprises a modified version of the first content, wherein the modified version comprises editing functions selected from a group consisting of doodling, pointer with zoom, pan, and/or rotate features on the first content.

10. The computing device of claim 9, wherein the picture receiving and processing block is to receive the modified version of the first content as a new content with a different unique identifier or as the first content having the same unique identifier along with the editing functions.

11. The computing device of claim 2, wherein the at least one first message and the at least one second message comprise a chat message, and wherein the first and second content is selected from a group consisting of audio, video, text, and image content.

12. The computing device of claim 1, wherein the picture processing and transmission block is to share the first content to the at least one recipient device by one of:
uploading the first content to a cloud storage and sharing a uniform resource locator (URL) of the stored first content with the at least one recipient device; and
directly transferring the first content to the at least one recipient device over the internet.

13. A method comprising:
associating, by a contextual content sharing module residing in a transmitting device, a unique identifier with a content to be shared with at least one recipient device;
sharing the content to the at least one recipient device by the contextual content sharing module;
tagging at least one message associated with the content to the unique identifier associated with the content by the contextual content sharing module; and
sharing the at least one tagged message and the unique identifier to the at least one recipient device by the contextual content sharing module to provide a contextual content sharing of the at least one tagged message.

14. The method of claim 13, further comprising:
receiving the content by the at least one recipient device;
extracting the unique identifier from the received content by a contextual content sharing module residing in the at least one recipient device; and storing the content and the extracted unique identifier in a database.

15. The method of claim 14, further comprising:
receiving the at least one tagged message and the unique identifier by the at least one recipient device;
associating the at least one tagged message with the content stored in the database based on the unique identifier by the contextual content sharing module residing in the at least one recipient device; and
rendering the at least one tagged message and associated content on a display of the at least one recipient device by the contextual content sharing module residing in the at least one recipient device.

16. The method of claim 15, wherein associating the at least one tagged message with the content stored in the database comprises:
extracting a thumbnail associated with the content from the database based on the unique identifier.

17. The method of claim 16, wherein rendering the at least one tagged message and the associated content on the display of the at least one recipient device comprises:
rendering the at least one tagged message along with the extracted thumbnail of the content on the display of the at least one recipient device.

18. The method of claim 17, further comprising:
rendering the content associated with a thumbnail as a background on the at least one recipient device upon selecting the thumbnail or message associated with the thumbnail.

19. The method of claim 13, further comprising:
receiving messages and associated unique identifiers from the at least one recipient device;
extracting thumbnails associated with the content from a database based on the unique identifiers, the database comprises content and unique identifiers associated with each content that were previously shared in a group conversation medium; and
displaying the messages with the thumbnails substantially adjacent to the messages from the at least one recipient device, wherein each thumbnail indicates a content that a user of a recipient device is viewing when the messages were shared in the group conversation medium.

20. The method of claim 13, further comprising:
receiving messages and associated unique identifiers from the at least one recipient device;
classifying the messages into a set of thumbnails based on the unique identifiers associated with the content, wherein each thumbnail indicates content that a user of a recipient device is viewing when the messages shared in a group conversation medium;
rendering the set of thumbnails on a user interface;
prompting to select one of the set of thumbnails; and
displaying the messages associated with the selected one of the thumbnails along with the content associated with the selected one of the thumbnails.

21. The method of claim 13, wherein the at least one message is a chat message, and wherein the content is selected from a group consisting of audio, video, text, and mage content.

22. The method of claim 13, wherein sharing the content comprises one of:
uploading the content to a cloud storage and sharing a uniform resource locator (URL) of the stored content with the at least one recipient device; and
directly transferring the content to the at least one recipient device over the internet.

23. The method of claim 13, further comprising:
providing an option to send an alert to the at least one recipient device to change a background content for the at least one recipient device to the shared content.

24. The method of claim 13, wherein the content comprises a modified version of a previously shared content, and wherein sharing the content comprises:
sharing the modified version of the content as a new content by creating a new unique identifier; or
sharing the modified version of the content with the same unique identifier along with editing functions.

25. A non-transitory computer-readable storage medium comprising instructions executable by a processor of an electronic device participating in a group conversation medium to:
receive at least one message and a unique identifier associated with a content from at least one other electronic device participating in the group conversation medium;
identify the content associated with the at least one message by comparing the received unique identifier with a database, wherein the database comprises content and unique identifiers associated with the content that were previously shared in the group conversation medium; and
render the at least one message and the identified content on a display of the electronic device.

26. The non-transitory computer-readable storage medium of claim 25, further comprising instructions to:
render the identified content as a background content upon selecting the content or the at least one message.

27. The non-transitory computer-readable storage medium of claim 25, wherein rendering the at least one message and the associated content on the display of the electronic device comprises:
extracting a thumbnail associated with the identified content from the database based on the unique identifier; and
displaying the at least one message with the extracted thumbnail substantially adjacent to the at least one message on the display, wherein the thumbnail indicates the content that a user of the electronic device is viewing when the at least one message was shared.

28. The non-transitory computer-readable storage medium of claim 25, wherein rendering the at least one message and the associated content on the display of the electronic device comprises:
rendering a set of thumbnails on a user interface of the group conversation medium, wherein each thumbnail indicates content that a user in the group conversation medium is viewing when messages were shared;
classifying the at least one message into one of the set of thumbnails based on the received unique identifier;
prompting to select one of the set of thumbnails; and
displaying the messages associated with the selected one of the thumbnails along with the content associated with the selected one of the thumbnails.

29. The non-transitory computer-readable storage medium of claim 25, wherein the at least one message is a chat message, and wherein the content is selected from a group consisting of audio, video, text, and image content.

30. The non-transitory computer-readable storage medium of claim 25, wherein the group conversation medium comprises a synchronous conversation medium, an asynchronous conversation medium or a combination thereof, wherein the asynchronous conversation medium is a medium in which an interaction is performed without requiring other users of the electronic devices to be online, and wherein the synchronous conversation medium is a medium in which an interaction is performed between online and active users.
